(19) United States
(12) Patent Application Publication
(10) Pub. No.: US 2026/0192488 A1
(43) Pub. Date: Jul. 9, 2026

(54) METHODS AND SYSTEMS FOR MECHANIZED RAMMED EARTH BLOCK CONSTRUCTION

(71) Applicant: Texas Tech University System, Lubbock, TX (US)

(72) Inventors: Jody Hicks, Hawley, TX (US); Steve Guzman, Edinburg, TX (US)

(21) Appl. No.: 19/131,500

(22) PCT Filed: Nov. 21, 2023
(86) PCT No.: PCT/US2023/080763

§ 371 Date: May 20, 2025

Related U.S. Application Data
(60) Provisional application No. 63/426,884, filed on Nov. 21, 2022.

(51) Int. Cl. B28B 1/04; B28B 7/00; B28B 7/10; B28B 13/02

(52) U.S. Cl. CPC B28B 1/04; B28B 7/0079; B28B 7/10; B28B 13/0215

(57) ABSTRACT

A rammed earth brick forming system comprises a compaction assembly configured to accept earthen material for compaction, a sub-frame assembly, wherein the compaction assembly is mounted to the compaction assembly, and an extractor configured to transport a finished brick out of the compaction assembly.

### CROSS REFERENCE TO RELATED PATENT APPLICATIONS

This patent application, also claims the priority and benefit under 35 U.S.C. § 119 (e) of U.S. Provisional Patent Application Ser. No. 63/426,884 filed Nov. 21, 2022, entitled “METHODS AND SYSTEMS FOR MECHANIZED RAMMED EARTH BLOCK CONSTRUCTION”. U.S. Provisional Patent Application Ser. No. 63/426,884 is herein incorporated by reference in its entirety.

### TECHNICAL FIELD

Embodiments are generally related to the field of construction. Embodiments are further related to the field of rammed earth construction. Embodiments are also related to the field of formed earth construction. Embodiments are further related to automated formwork. Embodiments are further related to prefabricated rammed earth construction.

### BACKGROUND

The population of earth recently exceed 8 billion people. The increasing population has created challenges, among which affordable, and energy efficient, construction is among the most pressing.

Traditional stick frame construction is a common mode of construction. It is cost effective and familiar to many in the construction industry. However, stick frame construction requires secondary installation solutions to be energy efficient, and demands the use of lumber which is a limited resource.

There are a number of alternatives to stick frame construction, one of which is the use of earthen materials to create walls or other structural elements. Rammed earth construction is a form of unbaked earthen construction, which has existed for thousands of years. Generally speaking, rammed earth comprises a mixture of subsoils compacted into a building form.

Rammed earth offers a number of potential benefits. For example, rammed earth has a high specific heat capacity and high material density. In addition, rammed earth offers excellent thermal mass with a high heat capacity. Thermal energy stored in the mass can be released into the interior of a building. As such, rammed earth provides excellent energy efficiency.

Rammed earth is also a low-carbon, non-toxic, and minimally processed alternative to established construction materials such as insulated lumber, concrete, and bricks. Earth as a construction material is a recyclable, readily available (often with the use of on-site soils) material with superior thermal mass, density, fire resistance, and is considerably less environmentally harmful than conventional lumber and concrete homes made throughout the continental United States.

Due to rammed earth's thermal mass, if used in the right climate, the walls are warmed passively by the sun or internal heating sources during the day and released into the building throughout the night. Alternatively, during the night, the cool air is absorbed into the walls and released into the structure during the day. Thus, rammed earth limits the temperature rise within the building due to environmental factors. For all of these reasons, rammed earth is a viable material for construction processes in the U.S. market.

However, there are currently major deficiencies in Rammed Earth construction. Specifically, there are currently technological gaps in in the setup and removal of the formwork necessary for rammed earth constructions, especially in prefab blocks. This problem is currently solved by manually setting up forms for the blocks. Each block has its own formwork. The formwork is then filled with mixed earthen materials and then given time to set. The physical labor, coupled with the time intensity of such current solutions is both inefficient and expensive.

As such, there is a need in the art for a new methods and systems for creating rammed earth forms, as disclosed herein.

### SUMMARY

In one embodiment, the systems and methods disclosed herein are directed to new systems and processes for construction.

In an embodiment systems and methods disclosed herein are directed to rammed earth construction.

In an embodiment, methods and systems are direct to tools for creating formed earth units.

In an embodiment, methods and systems are further directed to automated formwork for rammed earth construction.

In an embodiment, methods and system are direct to prefabricated rammed earth construction.

In an exemplary embodiment, a system comprises a compaction assembly configured to accept earthen material for compaction, a sub-frame assembly, wherein the compaction assembly is mounted to the compaction assembly, and an extractor configured to transport a finished brick out of the compaction assembly. In an embodiment, the compaction assembly further comprises a first side wall reinforced with a plurality of ribs, a base, and a second side wall attached to the subframe with at least one hinge. In an embodiment, the compaction assembly further comprises at least one actuator operably connected to the second side wall. In an embodiment, the compaction assembly further comprises a main door connected to the first side wall with a hinge and reinforcing bars configured on the main door. In an embodiment, the compaction assembly further comprises a latching assembly configured to connect the main door to the second side wall. In an embodiment, the compaction assembly further comprises a lockout configured to lock the second sidewall in a vertical position. In an embodiment, the lockout further comprises a sheath, a lockout bar in the sheath, a plurality of latch steps, and a latch lock configured to engage the latch steps. In an embodiment, the sub-frame assembly further comprises a base, at least one actuator mount formed on the base, a recess formed in the base, and a raised frame, wherein the extractor is mounted to the raised frame. In an embodiment, the system further comprises a block extraction insert configured to hold a formed brick. In an embodiment, the sub-frame assembly further comprises a plurality of rails formed in the base configured to engage with the block extraction insert. In an embodiment, the extractor further comprises an extractor plate and at least one linear actuator operably connected to the extractor place. Ion an embodiment, the extractor plate further comprises mounting ring standoffs configured to connect the extractor plate to the at least one linear actuator. In an embodiment the system further comprises a block top finishing grate configured to finish the top of a brick in the compaction assembly. In an embodiment, the system further comprises a material chute configured for directing material into the compaction assembly.

In an embodiment, a system comprises a compaction assembly configured to accept earthen material for compaction, a sub-frame assembly, wherein the compaction assembly is mounted to the compaction assembly, and an extractor configured to transport a finished brick out of the compaction assembly, and a material chute configured for directing material into the compaction assembly.

In an embodiment, the compaction assembly further comprises a first side wall reinforced with a plurality of ribs and a base, and a second side wall attached to the subframe with at least one hinge. In an embodiment, the compaction assembly further comprises at least one actuator operably connected to the second side wall. In an embodiment, compaction assembly further comprises a main door connected to the first side wall with a hinge and reinforcing bars configured on the main door. In an embodiment, the compaction assembly further comprises a latching assembly configured to connect the main door to the second side wall.

In an embodiment, the compaction assembly further comprises a lockout configured to lock the second sidewall in a vertical position. In an embodiment, the lockout further comprises: a sheath, a lockout bar in the sheath, a plurality of latch steps, and a latch lock configured to engage the latch steps.

In an embodiment, the sub-frame assembly further comprises a base, at least one actuator mount formed on the base, a recess formed in the base, and a raised frame, wherein the extractor is mounted to the raised frame.

In an embodiment, the system further comprises a block extraction insert configured to hold a formed brick.

In an embodiment, the sub-frame assembly further comprises a plurality of rails formed in the base configured to engage with the block extraction insert. In an embodiment, the extractor further comprises an extractor plate and at least one linear actuator operably connected to the extractor place. In an embodiment, the extractor plate further comprises mounting ring standoffs configured to connect the extractor plate to the at least one linear actuator.

In an embodiment, the system further comprises a block top finishing grate configured to finish the top of a brick in the compaction assembly.

In an embodiment, a rammed earth block making system comprises a compaction assembly configured to accept earthen material for compaction comprising a first side wall, a base, and a second side wall attached to the subframe with at least one hinge; a sub-frame assembly, wherein the compaction assembly is mounted to the compaction assembly; and an extractor configured to transport a finished brick out of the compaction assembly.

In an embodiment, a rammed earth system comprises a housing, a hopper system operably connected to a compression assembly mounted in the housing, and a brick conveyor arm configured to hold formed bricks. In an embodiment, the hopper system further comprises a hopper, and a meter configured to allow a specified amount of material to be dispensed from the hopper. In an embodiment, the compression assembly further comprises an insert comprising an enclosure configured to be filled with material and a compression plate, operably connected to at least one piston, and configured to compress material in the insert. In an embodiment, the compression plate further comprises surface detail protrusions. In an embodiment, the rammed earth system further comprises a power unit operably connected to the at least one piston. In an embodiment, the rammed earth system of claim further comprises a plurality of mounting tubes connected to the insert and a plurality of mounting rails, wherein the mounting tubes are configured to operably connect to the mounting rails.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1A depicts a front top perspective view of a rammed earth brick forming system, in accordance with the disclosed embodiments;

FIG. 1B depicts a rear top perspective view of a rammed earth brick forming system, in accordance with the disclosed embodiments;

FIG. 2A depicts a perspective view of a side wall comprising an aspect of a compaction assembly, in accordance with the disclosed embodiments;

FIG. 2B depicts a bottom side perspective view of a compaction assembly, in accordance with the disclosed embodiments;

FIG. 2C depicts a perspective view of additional aspects of a compaction assembly, in accordance with the disclosed embodiments;

FIG. 2D depicts an elevation view of an actuator associated with a side wall comprising an aspect of a compaction assembly, in accordance with the disclosed embodiments;

FIG. 2E depicts a view of a latch assembly comprising an aspect of a compaction assembly, in accordance with the disclosed embodiments;

FIG. 2F depicts a perspective view of a lockout comprising an aspect of a compaction assembly, in accordance with the disclosed embodiments;

FIG. 2G depicts a perspective view of a lockout comprising an aspect of a compaction assembly, in accordance with the disclosed embodiments;

FIG. 2H depicts aspects of the lockout comprising an aspect of a compaction assembly, in accordance with the disclosed embodiments;

FIG. 3A depicts a perspective view of a sub-frame assembly, in accordance with the disclosed embodiments;

FIG. 3B depicts a perspective view of a base comprising an aspect of a sub-frame assembly, in accordance with the disclosed embodiments;

FIG. 3C depicts a perspective view of a block extraction insert, in accordance with the disclosed embodiments;

FIG. 3D depicts an elevation view of an extractor plate, in accordance with the disclosed embodiments;

FIG. 3E depicts a side view of an extractor, in accordance with the disclosed embodiments;

FIG. 4A depicts a top perspective view of a finishing grate, in accordance with the disclosed embodiments;

FIG. 4B depicts a bottom perspective view of a finishing grate, in accordance with the disclosed embodiments;

FIG. 5A depicts a perspective view of a protective cowling, in accordance with the disclosed embodiments;

FIG. 5B depicts a side view of a protective cowling attached to the rammed earth brick forming system, in accordance with the disclosed embodiments;

FIG. 6 depicts another view of a rammed earth brick forming system, in accordance with the disclosed embodiments;

FIG. 7 depicts steps in a method for forming rammed earth bricks using the disclosed systems, in accordance with the disclosed embodiments;

FIG. 8 depicts another embodiment of a rammed earth brick forming system, in accordance with the disclosed embodiments;

FIG. 9A depicts an embodiment of a rammed earth block making system, in accordance with the disclosed embodiments;

FIG. 9B depicts a rear perspective view of a rammed earth block making system including aspects of a hopper system, in accordance with the disclosed embodiments;

FIG. 9C depicts a side elevation view of a rammed earth block making system including aspects of a compression assembly, in accordance with the disclosed embodiments;

FIG. 9D depicts additional aspects of a compression assembly, in accordance with the disclosed embodiments;

FIG. 9E depicts a front elevation view of a rammed earth block making system including aspects of a compression assembly, in accordance with the disclosed embodiments;

FIG. 9F depicts aspects of a compression assembly including a power unit, in accordance with the disclosed embodiments;

FIG. 9G depicts a side elevation view of a rammed earth block making system, in accordance with the disclosed embodiments; and

FIG. 9h depicts a rammed earth block making system on a trailer, in accordance with the disclosed embodiments;

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. In addition, the term “based on” may be understood as not necessarily intended to convey an exclusive set of factors and may, instead, allow for existence of additional factors not necessarily expressly described, again, depending at least in part on context.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Aspects of the embodiments illustrated herein can be combined with aspects from other embodiments without limitation.

Embodiments disclosed herein are directed to a mechanized formwork for rammed earth applications. For example, the embodiments comprise a specialized tool to aid in the construction of rammed earth structures by addressing a bottle neck in the work process. The embodiments can include a mechanized formwork for making rammed earth blocks or bricks, reducing ergonomic risk, and reducing overall labor cost. The embodiments can allow an operator to compact multiple blocks in the same formwork without the hassle of setting up the formwork each time a new block is required. As used herein, the term “block” or “brick can refer to a rammed earth block or brick formed with compaction of earthen material.

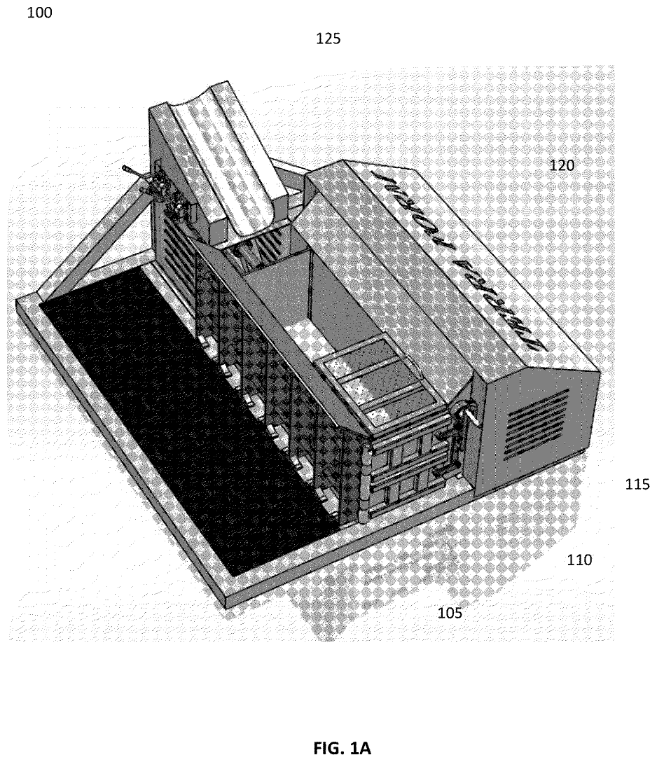

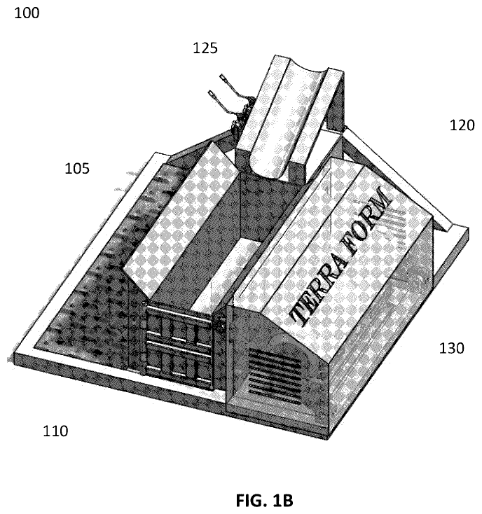

FIG. 1A and FIG. 1B illustrates aspects of an exemplary mechanized rammed earth system 100 in accordance with the disclosed embodiments. The system 100 generally comprises a number of components, used in concert, to form rammed earth blocks, which can be used for construction, or other such applications.

The system 100 can comprise a compaction assembly 105, where soil compaction takes place. This can include two side walls, and main door, a main door latching system, and lockout bars, and other associated components, all of which are further detailed herein.

The compaction assembly 105 is where all of the tamping action can take place. In operation, loose soil can be loaded into the compaction assembly 105 either by hand or via an integrated chute, which can, in certain embodiments, be operably connected to a hopper as further illustrated here. The soil mixture can optionally be compacted with a handheld pneumatic tamper (not shown). The compaction assembly includes a stationary half of the walls, and the tilting half of the walls which can be hinged.

The system further includes a sub-frame assembly 110, configured to hold the compaction assembly 105. The sub-frame assembly 110 can further include a base, extraction insert, and block extraction plate, among other components as further detailed herein. The sub-frame 110 is the base of the system 100, and ties the other components together. This sub-frame 110 features all of the cylinder ram mount points, structural members to hold the device rigid against the extraction forces, as well as the main mounting points for the compaction formwork itself. In certain embodiments, the parts of the subframe 110 can be welded together with structural-wall square tubing for sufficient rigidity and strength, and will include provisions for forklift access for transport of the machine.

Finally, the system 100 can also include a block top finishing grate 115, protective cowlings 120, a material chute 125, and a driver 130.

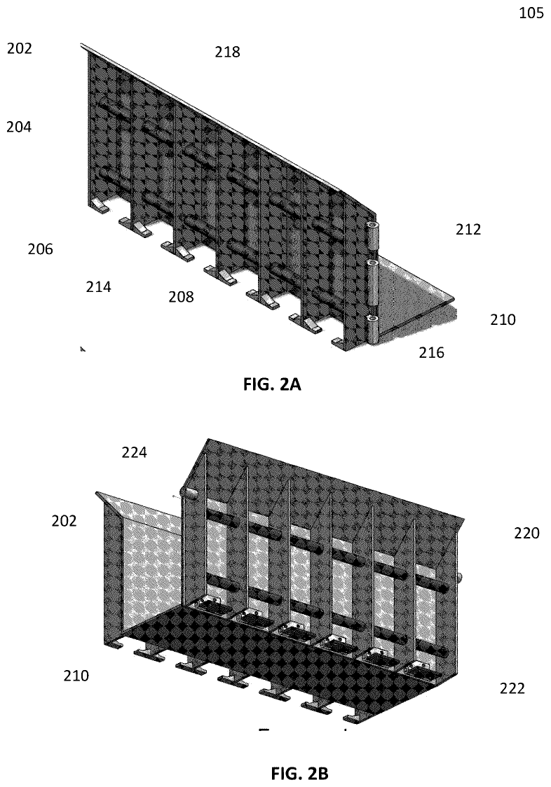

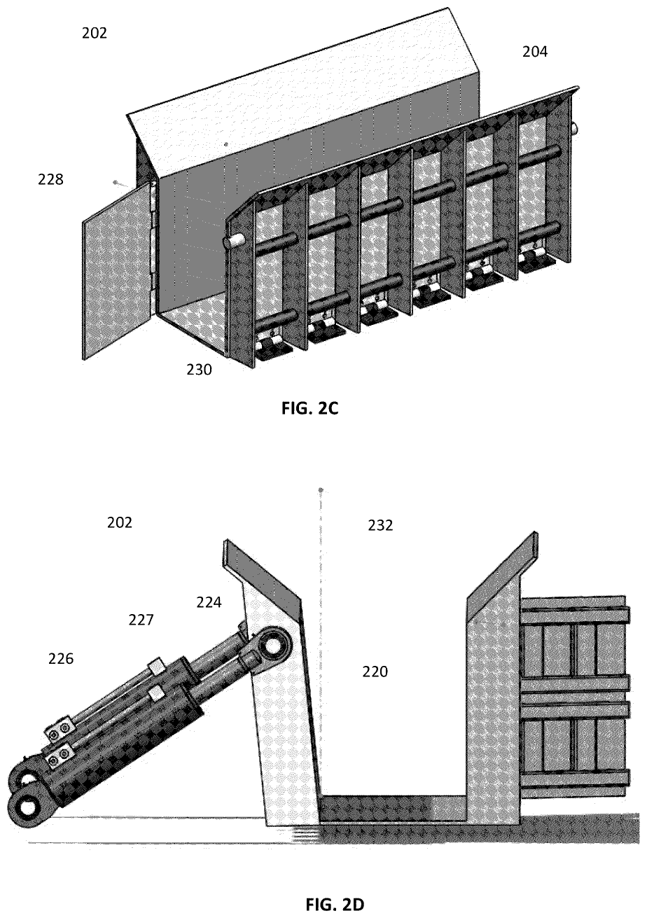

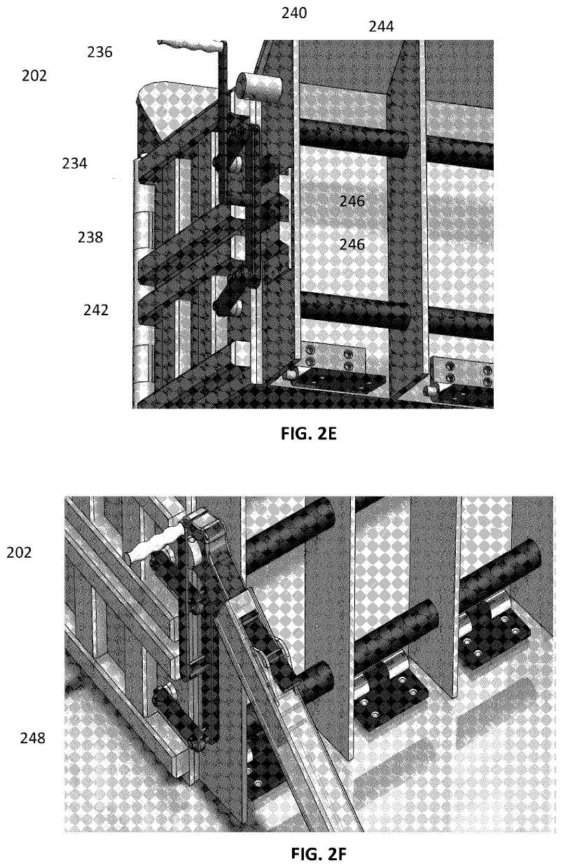

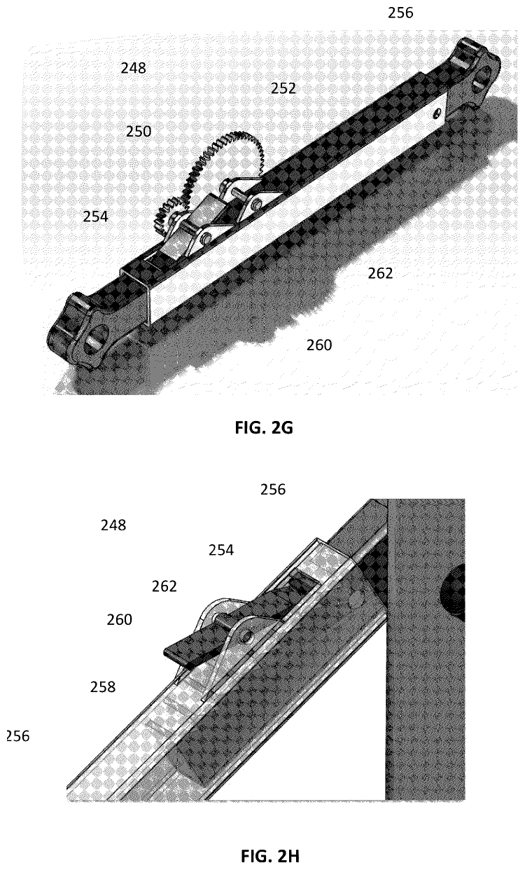

FIG. 2A illustrates a rigid framework 202 associated with the compaction assembly 105. The rigid half framework 202 comprises a side wall 204, reinforced with ribs 206 and support bars 208, and a base plate 210. The top of the side wall 204 includes a lip 218 which can be flared outward and buttressed by matching angles at the top 212 of the ribs 206. The base of the ribs 206 can be fitted with cleats 214 used for attachment to other components of the system 100. It should be noted the end of the side wall 204 can include a set of hinge knuckles 216 configured to engage with other hinge components formed on the main door.

FIG. 2B illustrates additional aspects of the ridged framework 202, namely, second side wall 220. The second side wall 220 can share some or all components with the first side wall 204. However, the second side wall 220 can further include hinges 222, which allow the second side wall 220 to rotate about the intersection between the base plate 210 and second side wall 220. The hinges 222 can be bolted to the base 302. The second side wall 220 can also include peg mounts 224, which can be connected to an actuator 226 used to raise and lower the second side wall 220.

FIG. 2C illustrates additional aspects of the compaction assembly 105. The compaction assembly 105 can further include a main door 228, which is connected to first side wall 204 with hinges 230.

In FIG. 2D actuators 226 are shown connected to pegs 224. The actuators 226, can comprise hydraulic or pneumatic pistons configured to extend/retract actuator arms 227. It should be appreciated that in other embodiments, the actuators 226 can comprise other actuators configured for linear motion. The linear actuators can be hinged at the top and bottom, as desired, to allow the side wall 220 to rotate from a vertical position to a position forming an obtuse angle as illustrated by line 232. The actuators 226 can be driven with a driver 130.

FIG. 2E provides a detailed view of aspects of the compaction assembly 105. The main door 228 can be configured with reinforcing bars 234. The main door 228 can further include a latching assembly 236 comprising latch mounts connected to an actuating latch frame 238 and latch handle 240. The actuating latch frame 238 includes a riser 242 configured with latch inserts 244. The latch inserts 244 are configured to engage with latch insert receptables 246 on the outer rib 206 on side wall 220.

The latching assembly 236 is configured to raise and lower the latch inserts 244. By raising the latch inserts 244, the main door can be disengaged form the second side wall 220. When the latch inserts 244 are lowered into the latch insert receptacles 246, the main door 228 can be securely engaged to the second side wall 220.

FIG. 2F illustrates additional aspects of the compaction assembly 105. The actuators 226 can further include a lockout 248. The lockout 248 details are further illustrated in FIG. 2G and FIG. 2H. The lockout 248 can comprise a gear assembly 250 mounted to a sheath 252. The sheath 252 can include a window 254 providing access to the internal volume, and a lockout bar 256. The lockout bar 256 can be configured to latch steps 258. The sheath 252 can include a latch lock 260 mounted on a pivot 262. The latch lock 260 is configured to be proximate to the window 254, so that it can be engaged with the latch steps 258 to lock the lockout 248 in place.

In operation, the relief mechanism can reduce the amount of force in the lateral direction created during the tamping (compaction) process. This can reduce the amount of force required to extract the brick from inside the formwork. The lockout 248 can increase longevity and ease maintenance/repair. The lockout 248 utilizes a toothed link and a locking lever as disclosed. The lever can be engaged and released by a series of mechanically advantaged gears in the gear assembly, which can be driven by a hydraulic motor, or other such drivers including manual methods, such as a lever. The orientation of the handle and gears provides a mechanical advantage, which can reduce operator strain while releasing the lever from the locked position. Once released, the compactor can tilt open, and allow the extractor to push the rammed earth block more efficiently out of the formwork, as well as preserve surface finish of the outer face.

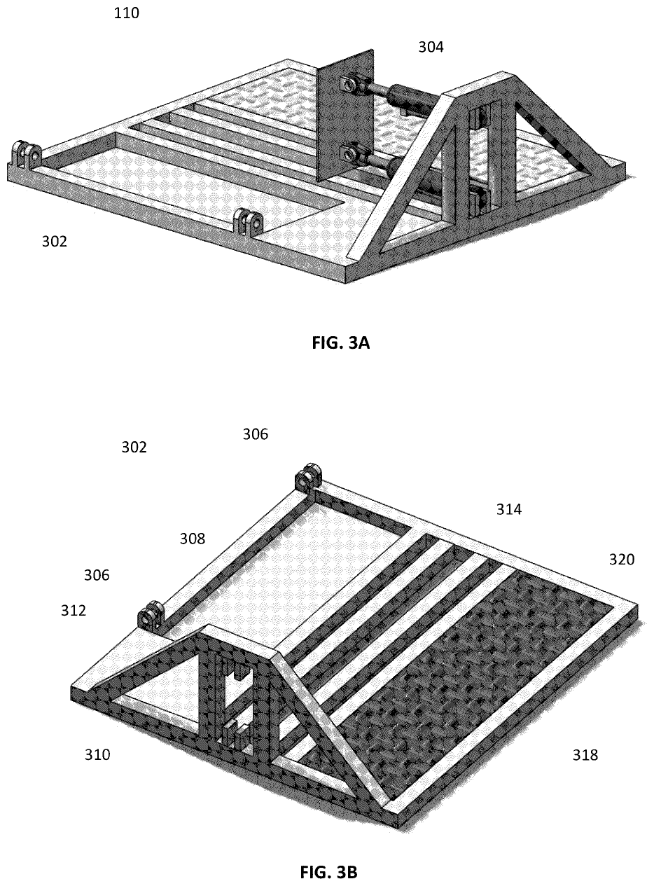

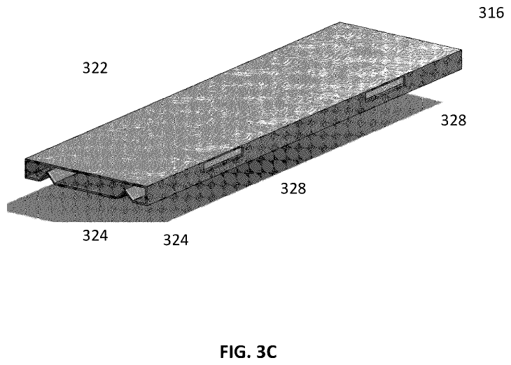

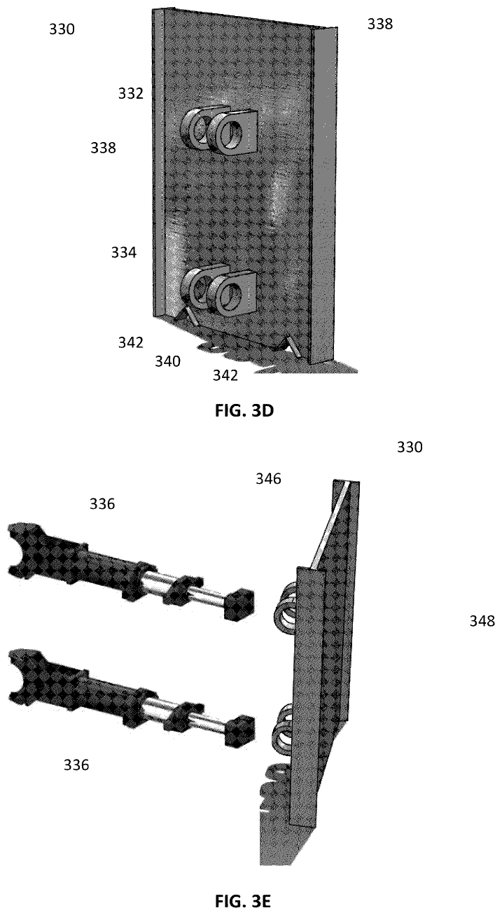

FIG. 3A illustrates aspects of a sub-frame assembly 110 in accordance with the disclosed embodiments. The sub-frame assembly 110 serves as the platform on which other aspects of the system 100, such as the compaction assembly 105, are mounted. The sub-frame assembly 110 can include a base 302 and extractor 304, among other components as further detailed herein.

As illustrated in FIG. 3B, the base 302 comprises a pair of actuator mounts 306 where the ends of the respective actuators 226 are affixed. A recess 308 can be formed in the base 302. The recess 308 is configured to hold the driver or other such components. The back end 310 includes a raised frame 312, configured to mount the extractor 304. The base 302 further comprises rails 314 configured to house the block extraction insert 316. The lateral side 318 of the base 302 also includes a textured surface 320 where operators can stand.

Aspects of the block extraction insert 316 are illustrated in FIG. 3C. The block extraction insert 316 comprises a rectangular body 322 with two angular slides 324 on the bottom side 326. The block extraction insert 316 is also configured with side openings 328. The block extraction insert 316 is configured to allow blocks compacted with the compaction assembly to be slid out of the system 100 for placement.

FIG. 3D and FIG. 3E illustrate aspects of the extractor 304. The extractor 304 comprises an extractor plate 330. The extractor plate 330 includes outer ribs 338 to lend strength to the extractor 304 and to fit flush with the inner sides of the side walls 204 and 220 respectively. The extractor plate 330 further includes a top set of mounting ring standoffs 332 and a lower set of mounting ring standoffs 334. The top mounting ring standoffs 332 and bottom mounting ring standoffs 334 are configured to mount to linear actuators 336. The bottom 340 of the extractor plate 330 can further include slide relief cutouts 342.

As illustrated in FIG. 3E, each of the linear actuators can mount to the rear 346 of the extractor 304 via top mounting ring standoffs 332 and bottom mounting ring standoffs 334 respectively. FIG. 3E illustrates that the linear actuators 336 can extend as illustrated by arrow 348, the extractor 304 to push a formed rammed earth unit out of the system 100.

In operation, the extractor 304 is used to remove the compressed brick from the system 100. This system 100 is composed of an extraction plate 330 and a specialized insert. The extraction plate 330 is connected to two hydraulic cylinders mounted to the subframe 312, and can apply the needed force to remove the brick far enough to clear the formwork. The insert 316 itself, functions by a carriage and ways principle, and can serve as the platform the brick will “ride” on. This will allow structural support for the brick until it is cured enough to handle, and allow for easy maneuvering with a forklift.

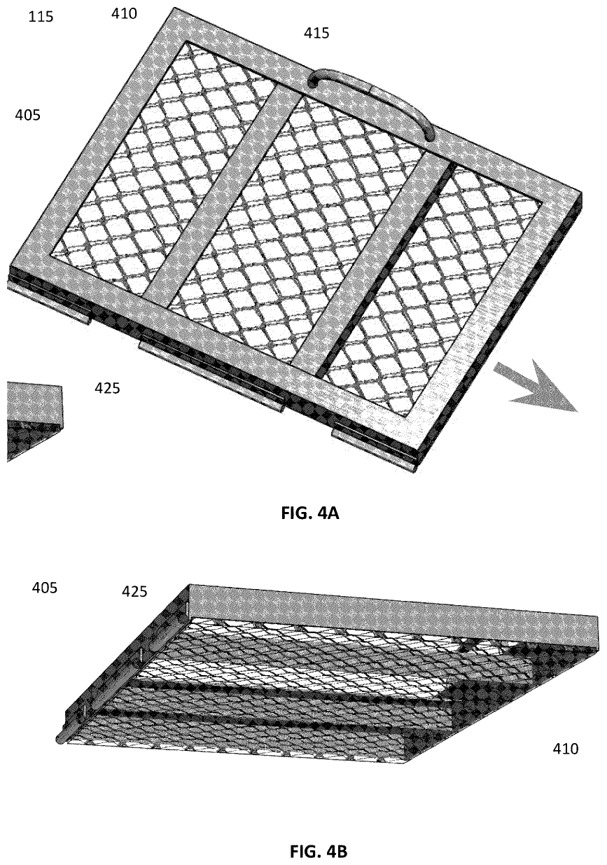

FIG. 4A and FIG. 4B illustrate aspects of a block top finishing grate 115 configured to finish the top of a brick in the compaction assembly. The block top finishing grate 115 can comprise a frame 405 with a finishing grate 410 mounted thereto. As illustrated in FIG. 4B the frame 405 can have a depth, such that the finishing grate 410 on the underside of the frame 405. The finishing grate can comprise chicken wire, or other such wire material. A handle 415 can be installed on the frame 405. The opposing end 420 is fitted with hinge knuckles 425 which allow the finishing grate to be rotated into position.

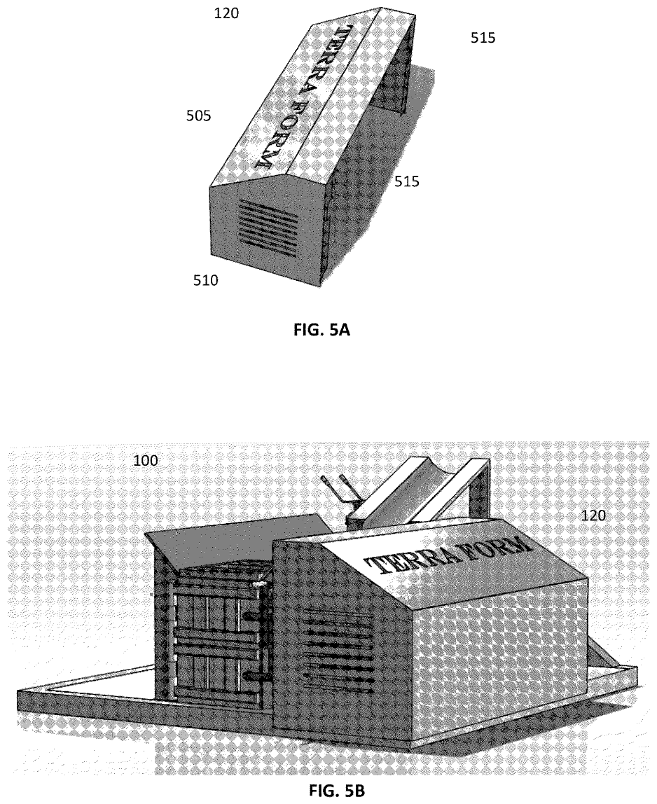

FIG. 5A illustrates protective cowling 120. The protective cowling 120 comprises a cowling body 505 configured to connect to the side of the side wall 220 with the mounting tabs 515. Sides of the cowling can include vents 510 to allow ventilation to the driver and other components inside the protective cowling, as illustrated in FIG. 5B. It should be appreciated that the protective cowling 120 is configured to prevent access to moving parts while the system 100 is in operation.

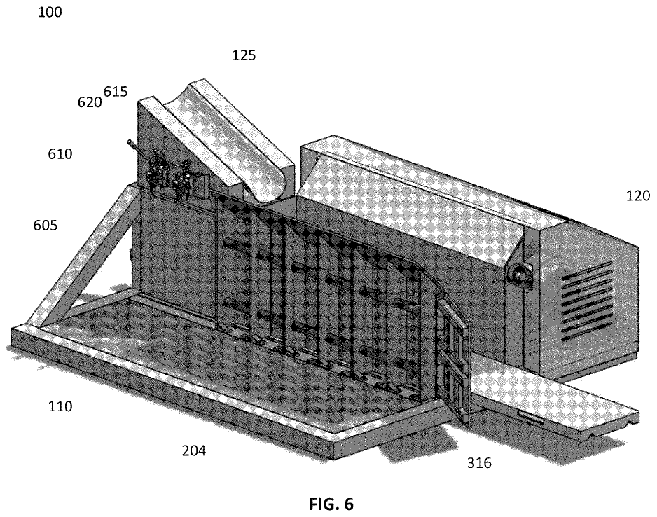

FIG. 6 illustrates additional aspects of the mechanized rammed earth system 100 in accordance with the disclosed embodiments. As illustrated, the system 100 comprises a material chute 125 attached to extractor cover 605, which covers the extractor assembly. The material chute 125 provides a pathway for material to be deposited into the compaction assembly 105 and can be operably connected to a hopper in certain embodiments.

The system 100 further includes controller 610. The controller 610 can include a computer system, circuit board, pneumatic control, hydraulic controller, or the like. The controller 610 can include an extractor controller lever 615 which can be used to extend and retract the extractor. The controller 610 can further include side wall controller lever 620 which can be used to raise and lower the side wall 220.

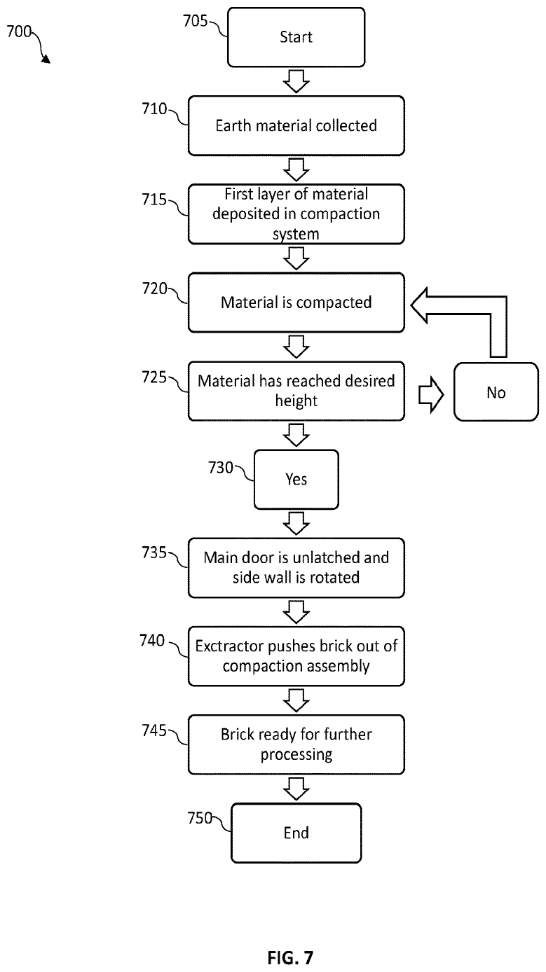

FIG. 7 illustrates a method 700 associated with the production of a rammed earth block or brick using the disclosed systems in accordance with the disclosed embodiments. The method begins at 705. At step 710 material for compaction into a brick can be collected. In certain embodiments, this can comprise damp earth material or other such material.

At step 715 a first layer of material can be deposited into the compaction assembly, in certain embodiments, via material chute 125. Next at step 720 the layer of material can be compacted to high density. In exemplary embodiments, this can be done with a pneumatic rammer, or other such device. This process can be repeated with additional layers of material and compaction as illustrated at step 725, until the brick is the desired height as shown at 730.

Once the brick is compacted and is at the desired height, at step 735, the latch to the main door can be released and the side wall can be rotated away from the brick with the controller. This may require release of the lockout. Next, at step 740 the extractor can push the brick out of the compaction assembly on the block extraction insert. The brick is now ready for further processing and/or use in a construction application as illustrated at 745. The method ends at 750.

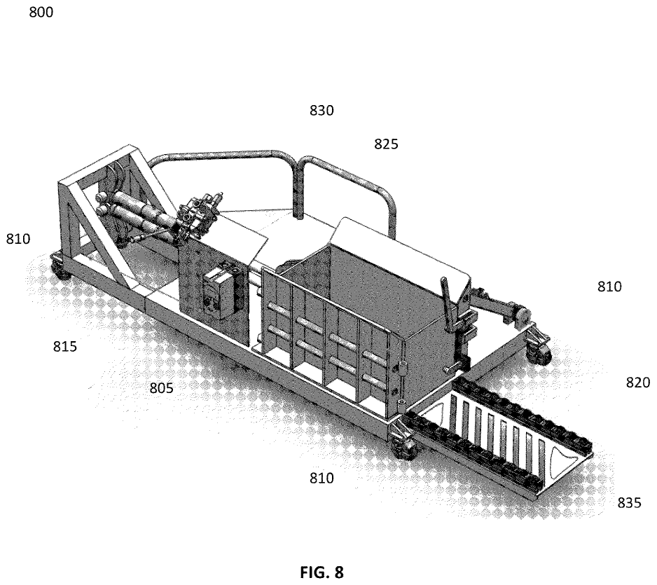

FIG. 8 illustrates additional embodiments of a rammed earth compaction assembly 800, in accordance with the disclosed embodiments. Various aspects of the embodiments illustrated in FIG. 8 are identical to those of other embodiments. In this embodiment, the base structure 805 is configured with wheel assemblies 810, which allow the rammed earth compaction assembly to be rolled to a desired location on site.

The embodiments further include a full length extractor 815 which can be used to push completed blocks onto conveyor assembly 820. The conveyor assembly 820 includes moving treads 835 configured to engage the bottom surface of the completed blocks with friction and pull them out of the compactor. The base structure 805 further includes an operator platform 825 with guard rails 830 which can provide operator access to aspects of the rammed earth compaction assembly 800.

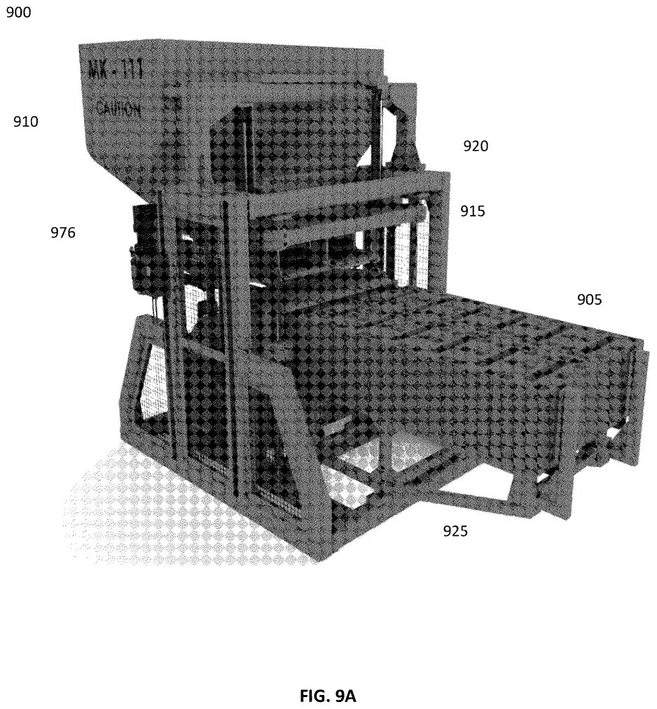

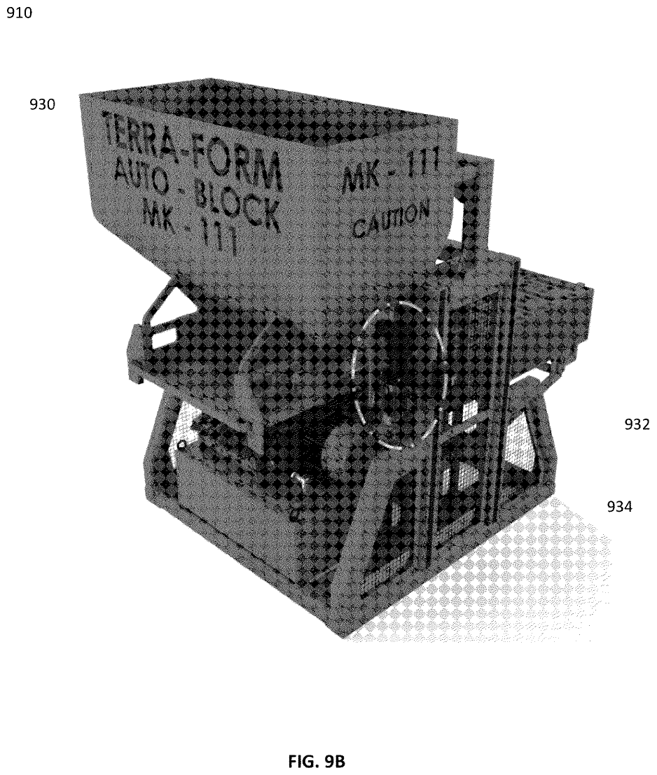

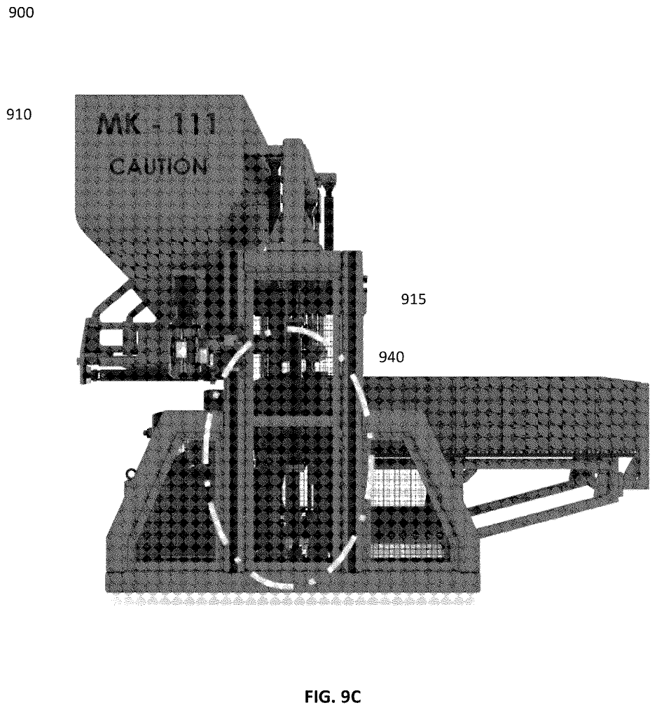

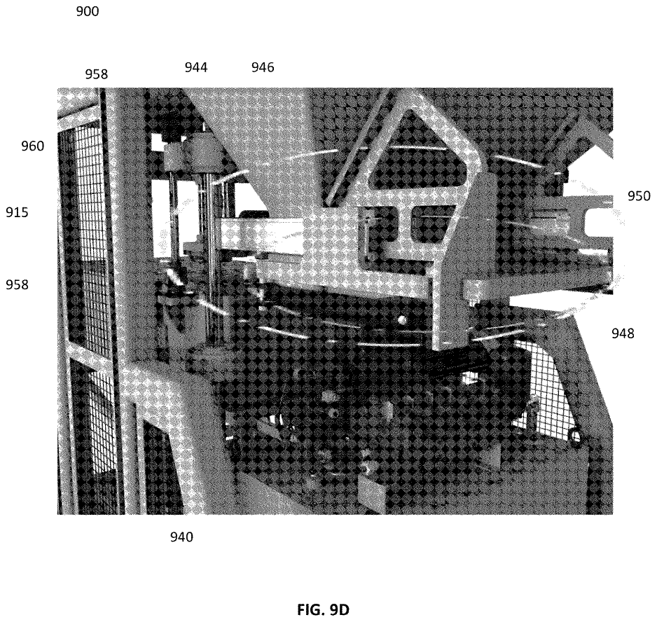

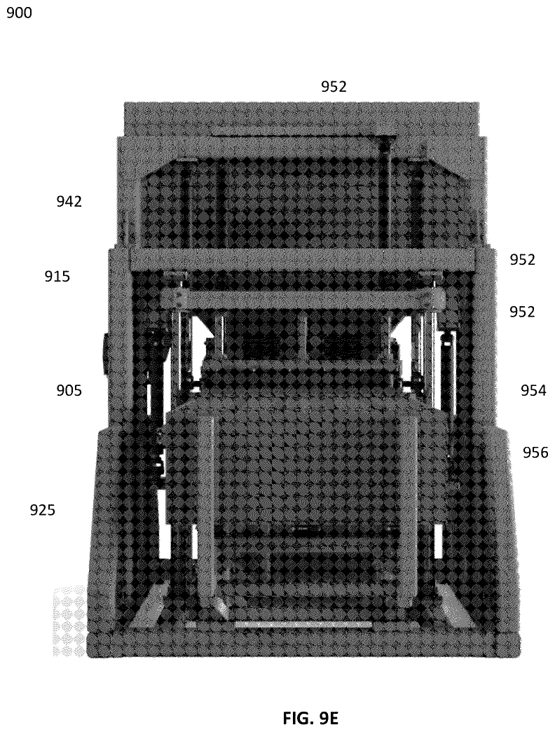

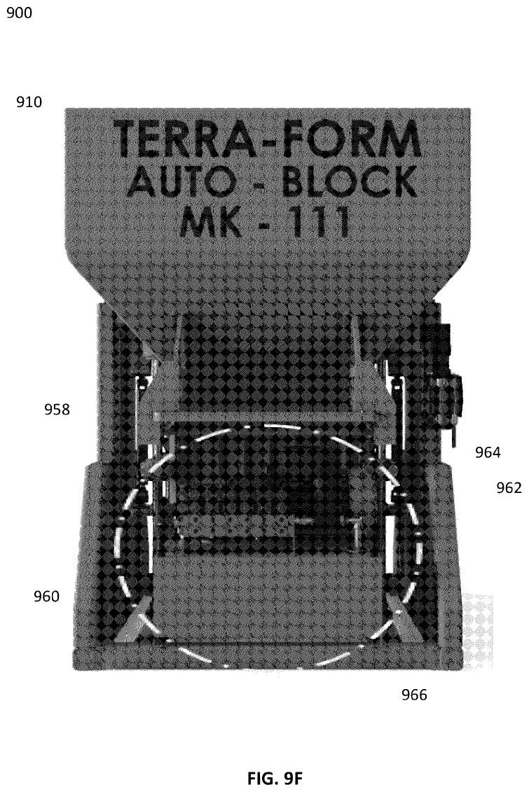

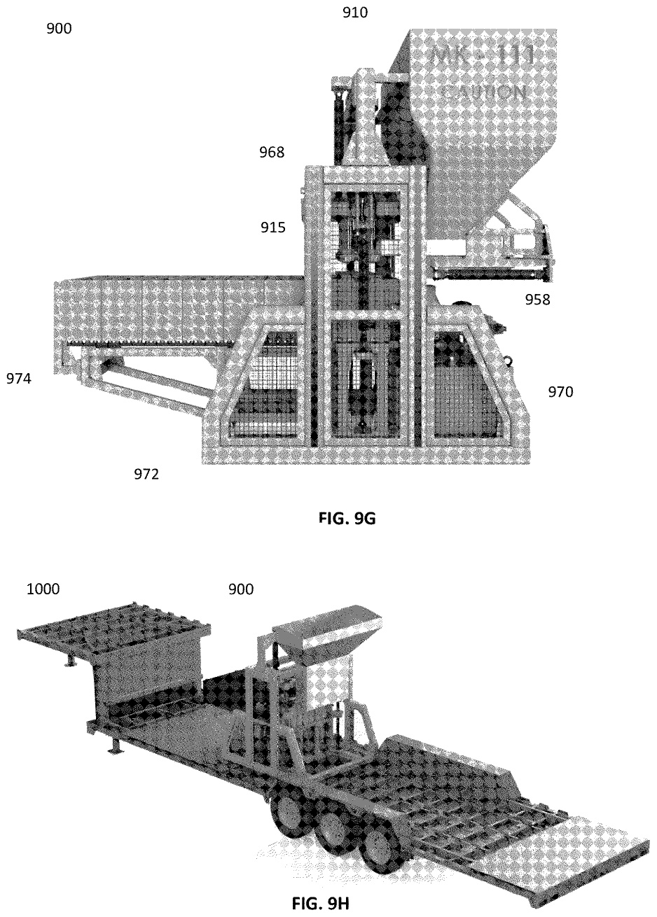

FIGS. 9A-9H illustrate another embodiment of a rammed earth system 900 in accordance with the disclosed embodiments. The rammed earth system 900 is configured for material loading, vibration-forming, and ejection of various sizes of rammed earth blocks 905 (REBs). REBs 905 can range in size. The exemplary system 900 illustrated in FIGS. 9A-9H can produce 3-foot-long, 14-inch tall blocks, but blocks of other sizes and shapes are possible as further detailed herein. The blocks 905 can be configured with interlocking geometry to create an air-tight, structurally sound fit for a myriad of building applications, even in seismic zones.

The rammed earth system 900 generally comprises a hopper system 910 operably connected to a compression assembly 915 mounted in a housing 920. A brick conveyor arm 925 can be used to hold formed bricks 905 as they are completed. A control assembly 976 is also provided to control the operation of the compression assembly 915.

FIG. 9B illustrates aspects of the hopper system 910. In certain embodiments, the hopper system 910 includes a hopper 930 mounted to the housing 920. The hopper is configured to accept rammed earth block forming materials. An auger (not shown) can be configured in the hopper 930 to help keep the rammed earth block forming materials thoroughly mixed. A meter 932 can be provided between the hopper 930 and compression assembly. The meter 932 is illustrated inside line 934, and can comprise a valve configured to allow a specified amount of soil for each layer of the REB to be dispensed from the hopper 930 and enter the compression assembly 915 during the block formation process.

FIG. 9C provides a side elevation view of the system 900 showing aspects of the compression assembly 915 (illustrated inside the dotted line) in accordance with the disclosed embodiments. The compression assembly 915 can include an insert 940 comprising an enclosure that can be filled with rammed earth block forming materials. The insert 940 can generally comprise a series of walls and a base. The top of the insert 940 can remain open so that a compression plate 942 can be used to compress the layers of material in the insert 940 as further detailed herein. The insert 940 can be configured to be removable, and can therefore be replaced with other inserts of other shapes and sizes. For example, insert 940 can be configured with curved walls, angled walls, etc., if a design calls for such a shape.

In FIG. 9D additional aspects of the compression assembly 915 are visible. The compression assembly can comprise a fill box 944 (outlined by broken circle 946). The fill box 944 can include overlapping gates that help meter the raw material into the insert form 940. The fill box 944 rides on guide rails 946. Rammed earth block forming materials are deposited from the moving fill box 944 into the form 940 at a specific layer height (e.g., 6″). The fill box 944 works in concert with the main hopper gate 948 (outlined by broken circle 950), which is responsible for holding back loose material in the hopper 930. Once the fill box 944 is back in its home position, the compression cycle begins.

The insert 940 can be configured with mounting tubes 958 configured to fit on mounting rails 960. The mounting rails 960 allow the system 900 to be accept insert 940 forms of various shapes and sizes. If a different size or shaped insert 940 is required, the insert 940 can be installed on the mounting rails 940 which ensure the new insert 940 is properly positioned.

FIG. 9E provides a front elevation view inside the system 900, showing aspects of the compression assembly 915. The compression assembly 915 includes compression plate 942 which is operably connected to one or more pistons 952. The compression plate 942 can include surface detail protrusions 954 which can be configured to leave surface details (e.g., peg holes or slots) in the block 905. It should be appreciated the surface detail protrusions can also be voids if protrusions on the block 905 are desired. The front wall 956 of the form 940 can comprise a gate (as described with respect to other embodiments), so that after the compression cycle is complete the brick 905 can be moved out of the compression assembly 915 and onto the brick conveyor arm 925.

FIG. 9F illustrates aspects of a power unit 958. The power unit 958 can comprise a hydraulic power unit, which can be mounted on the housing 920. The hydraulic power unit 958 (circled by the broken line) can comprise a solenoid valve assembly 960, motor 962, pump 964, and hydraulic tank 966. The power unit 958 is operably connected to the pistons 952 and is used to apply compressive force on the rammed earth block forming materials in the insert 940.

FIG. 9G illustrates a side elevation view of the rammed earth system 900 in accordance with the disclosed embodiments. The housing 920 can comprise a central tower 968 configured to house the compression assembly, along with a rear brace 970 configured to house the power unit 958, and a front brace 972 configured to support the brick conveyor arm 925.

The brick conveyor arm 925 can extend in the opposite direction from the hopper system 910, allowing for good balance when fully loaded. The rollers 974 allow the bricks 905 to slide along the brick conveyor arm 925. The brick conveyor arm is configured to hold up to six blocks (although the brick conveyor arm 925 can hold other numbers of blocks 905 if necessary). For example, if the brick conveyor arm 925 is configured to hold 1 cu yd in volume when compressed, then the hopper system 910 can also be configured to hold approximately 1 cu yd, making for easy material and mix calculations.

FIG. 9H further illustrates that the rammed earth system 900 can be configured to fit on a flatbed truck or trailer 1000. The trailer 1000 can be used to transport the system 900 from one location to the next as [symbol] perations.

As such, the disclosed embodiments are configured to mitigate inefficiencies in the conventional rammed earth construction process by reducing labor costs, operating costs, and minimizing ergonomic risks. Prefabricated unitized block construction is the most cost effective and simple course of action for rammed earth construction. The embodiments comprise in-place mechanized formwork responsible for the geometric control and extraction of the rammed earth block for building walls or wall-like structures.

The embodiments address major bottlenecks in conventional rammed earth construction such as material delivery into the formwork, the variability of geometry, and reduced construction time and cost. Hence, the disclosed embodiments offer advantages to engineers, individuals in the construction industry, or hobbyists and provides an exceptional foundation for the implementation of earth as a viable building material.

Based on the foregoing, it can be appreciated that a number of embodiments, preferred and alternative, are disclosed herein.

In an embodiment, a system comprises a compaction assembly configured to accept earthen material for compaction, a sub-frame assembly, wherein the compaction assembly is mounted to the compaction assembly, and an extractor configured to transport a finished brick out of the compaction assembly, and a material chute configured for directing material into the compaction assembly.

In an embodiment, the compaction assembly further comprises a first side wall reinforced with a plurality of ribs and a base, and a second side wall attached to the subframe with at least one hinge. In an embodiment, the compaction assembly further comprises at least one actuator operably connected to the second side wall. In an embodiment, compaction assembly further comprises a main door connected to the first side wall with a hinge and reinforcing bars configured on the main door. In an embodiment, the compaction assembly further comprises a latching assembly configured to connect the main door to the second side wall.

In an embodiment, the compaction assembly further comprises a lockout configured to lock the second sidewall in a vertical position. In an embodiment, the lockout further comprises: a sheath, a lockout bar in the sheath, a plurality of latch steps, and a latch lock configured to engage the latch steps.

In an embodiment, the sub-frame assembly further comprises a base, at least one actuator mount formed on the base, a recess formed in the base, and a raised frame, wherein the extractor is mounted to the raised frame.

In an embodiment, the system further comprises a block extraction insert configured to hold a formed brick.

In an embodiment, the sub-frame assembly further comprises a plurality of rails formed in the base configured to engage with the block extraction insert. In an embodiment, the extractor further comprises an extractor plate and at least one linear actuator operably connected to the extractor plate. In an embodiment, the extractor plate further comprises mounting ring standoffs configured to connect the extractor plate to the at least one linear actuator.

In an embodiment, the system further comprises a block top finishing grate configured to finish the top of a brick in the compaction assembly.

In an embodiment, a rammed earth block making system comprises a compaction assembly configured to accept earthen material for compaction comprising a first side wall, a base, and a second side wall attached to the subframe with at least one hinge; a sub-frame assembly, wherein the compaction assembly is mounted to the compaction assembly; and an extractor configured to transport a finished brick out of the compaction assembly.

In an embodiment, a rammed earth system comprises a housing, a hopper system operably connected to a compression assembly mounted in the housing, and a brick conveyor arm configured to hold formed bricks. In an embodiment, the hopper system further comprises a hopper, and a meter configured to allow a specified amount of material to be dispensed from the hopper. In an embodiment, the compression assembly further comprises an insert comprising an enclosure configured to be filled with material and a compression plate, operably connected to at least one piston, and configured to compress material in the insert. In an embodiment, the compression plate further comprises surface detail protrusions. In an embodiment, the rammed earth system further comprises a power unit operably connected to the at least one piston. In an embodiment, the rammed earth system of claim further comprises a plurality of mounting tubes connected to the insert and a plurality of mounting rails, wherein the mounting tubes are configured to operably connect to the mounting rails.

It should be appreciated that variations of the above-disclosed and other features and functions, or alternatives thereof, may be desirably combined into many other different systems or applications. It should be understood that various presently unforeseen or unanticipated alternatives, modifications, variations, or improvements therein may be subsequently made by those skilled in the art which are also intended to be encompassed by the following claims.

What is claimed is:

1. A system comprising:
a compaction assembly configured to accept earthen material for compaction;
a sub-frame assembly, wherein the compaction assembly is mounted to the compaction assembly;
an extractor configured to transport a finished brick out of the compaction assembly; and
a material chute configured for directing material into the compaction assembly.

2. The system of claim 1 wherein the compaction assembly further comprises:
a first side wall reinforced with a plurality of ribs;
a base; and
a second side wall attached to the sub-frame with at least one hinge.

3. The system of claim 2 wherein compaction assembly further comprises:
at least one actuator operably connected to the second side wall.

4. The system of claim 2 wherein compaction assembly further comprises:
a main door connected to the first side wall with a hinge; and
reinforcing bars configured on the main door.

5. The system of claim 4 wherein compaction assembly further comprises:
a latching assembly configured to connect the main door to the second side wall.

6. The system of claim 2 wherein compaction assembly further comprises:
a lockout configured to lock the second sidewall in a vertical position.

7. The system of claim 6 wherein the lockout further comprises:
a sheath;
a lockout bar in the sheath;
a plurality of latch steps; and
a latch lock configured to engage the latch steps.

8. The system of claim 2 wherein the sub-frame assembly further comprises:
a base;
at least one actuator mount formed on the base;
a recess formed in the base; and
a raised frame, wherein the extractor is mounted to the raised frame.

9. The system of claim 1 further comprising:
a block extraction insert configured to hold a formed brick.

10. The system of claim 9 wherein the sub-frame assembly further comprises:
a plurality of rails formed in the base configured to engage with the block extraction insert.

11. The system of claim 1 wherein the extractor further comprises:
an extractor plate; and
at least one linear actuator operably connected to the extractor plate.

12. The system of claim 11 wherein the extractor plate further comprises:
mounting ring standoffs configured to connect the extractor plate to the at least one linear actuator.

13. The system of claim 1 further comprising:
a block top finishing grate configured to finish the top of a brick in the compaction assembly.

14. A rammed earth block making system comprising:
a compaction assembly configured to accept earthen material for compaction;
a sub-frame assembly comprising a first side wall, a base, and a second side wall attached to a sub-frame with at least one hinge, wherein the compaction assembly is mounted to the sub-frame assembly; and
an extractor configured to transport a finished brick out of the compaction assembly.

15. A rammed earth system comprising:
a housing;
a hopper system operably connected to a compression assembly mounted in the housing; and
a brick conveyor arm configured to hold formed bricks.

16. The rammed earth system of claim 15 wherein the hopper system further comprises:
a hopper; and
a meter configured to allow a specified amount of material to be dispensed from the hopper.

17. The rammed earth system of claim 15 wherein the compression assembly further comprises:
an insert comprising an enclosure configured to be filled with material; and
a compression plate, operably connected to at least one piston and configured to compress material in the insert.

18. The rammed earth system of claim 17 with the compression plate further comprises:
surface detail protrusions.

19. The rammed earth system of claim 17 further comprising:
a power unit operably connected to the at least one piston.

20. The rammed earth system of claim 17 further comprising:
a plurality of mounting tubes connected to the insert; and
a plurality of mounting rails, wherein the mounting tubes are configured to operably connect to the mounting rails.
